(19) United States
(12) Patent Application Publication
(10) Pub. No.: US 2026/0058432 A1
(43) Pub. Date: Feb. 26, 2026

(54) FIBER LASER AMPLIFIER COMPRISING A LATERAL PUMPING DEVICE

(71) Applicant: COMPAGNIE INDUSTRIELLE DES LASERS CILAS, ORLÉANS (FR)

(72) Inventors: Etienne GENIER, ORLÉANS (FR); Jean-Eucher MONTAGNE, ORLÉANS (FR)

(21) Appl. No.: 19/111,990

(22) PCT Filed: Sep. 19, 2023
(86) PCT No.: PCT/EP2023/075854

§ 371 Date: Mar. 14, 2025

(30) Foreign Application Priority Data
Sep. 19, 2022 (FR) FR2209335

(51) Int. Cl. H01S 3/094; H01S 3/067

(52) U.S. Cl. CPC H01S 3/094007; H01S 3/06716; H01S 3/06733; H01S 3/094042

(57) ABSTRACT

A fiber optical amplifier, comprising an amplifying optical fiber comprising a doped core, at least one optical cladding, and an outer covering. The optical amplifier also comprising at least one lateral pumping device, comprising a pumping optical fiber assembled with the amplifying optical fiber at a junction zone. The outer covering is made of a material with high thermal conductivity, covers most of the perimeter of the amplifying optical fiber at the segments of this fiber which surround the junction zone, and covers part of this perimeter at the segment of this fiber comprising the junction zone, so that the outer covering extends without interruption on the amplifying optical fiber.

### RELATED APPLICATIONS

This application is a national phase of International Patent Application No. PCT/EP2023/075854, filed on Sep. 19, 2023, which claims the benefit of French Patent Application Number 2209335 filed on Sep. 19, 2022, the entire disclosures of which are incorporated herein by way of reference.

### FIELD OF THE INVENTION

The present invention relates to laser amplifiers. It relates in particular to fiber laser amplifiers, wherein a light beam is amplified as it propagates through an amplifying optical fiber.

In particular, the invention relates to such fiber laser amplifiers comprising a lateral pumping device

### BACKGROUND OF THE INVENTION

Fiber laser amplifiers are optical devices well known to those skilled in the art, wherein light radiation is amplified as it propagates along an amplifying optical fiber.

Amplifying optical fibers are generally composed of at least one core surrounded by an optical cladding. The core is usually a silica matrix that is doped, usually with rare-earth ions, to form an optical amplifying medium. This core of the optical fiber is designed to guide and amplify the light beam to be amplified.

The core is usually surrounded by an optical cladding, often made of silica with a refractive index lower than that of the core it surrounds. This index jump advantageously keeps the light beam to be amplified in the core, without it being able to escape into the optical cladding.

The optical cladding is itself capable of guiding a light beam along the amplifying optical fiber. A so-called “pump” luminous flux is introduced into this optical cladding. As it travels along the optical cladding, this pump luminous flux passes through the doped core, where its photons are absorbed by the core's doping ions, which then enter an excited state. These excited core doping ions then amplify the light beam to be amplified circulating in the core.

The optical cladding surrounding the core of the optical fiber must guide the pump luminous flux. To achieve this, this optical cladding can be surrounded by another optical cladding, the so-called outer optical cladding, whose refractive index is lower than that of the optical cladding surrounding the core, so that the index jump prevents the pump luminous flux from escaping from the optical cladding surrounding the core.

It is also possible for the optical cladding surrounding the core, or an outer optical cladding surrounding the optical cladding surrounding the core, to be surrounded by an outer covering, which may for example be a reflective covering helping to maintain the pump luminous flux in the amplifying optical fiber. In many cases, this outer covering 14 is made of polymers. It is usually non-transparent or even opaque. It is generally used to protect the amplifying optical fiber from mechanical stress.

Fiber laser amplifiers are increasingly being used to generate high-power laser beams. They can be included in a laser cavity, or used to amplify a laser beam previously produced in a cavity.

However, this use of fiber laser amplifiers to obtain high-power laser beams comes up against difficulties that limit the power of the light beam obtained.

Thus, optical amplification in a fiber laser amplifier generates non-linear effects, well known to those skilled in the art, which are highly detrimental to the quality of the amplified light beam or its spectral sharpness. These non-linear effects increase sharply with the length of the amplifying optical fiber. They therefore require fiber laser amplifiers to use only a limited length of amplifying optical fiber. An increase in the amplification power of a fiber laser amplifier cannot therefore be achieved by unlimited lengthening of the amplifying optical fiber, but rather requires an increase in the amplification power per unit length of the amplifying optical fiber.

To achieve very high-power amplification with a limited length of amplifying optical fiber, a very high-power pump luminous flux must be introduced into the optical cladding of the amplifying optical fiber.

Conventionally, the pump luminous flux can be introduced into the optical cladding surrounding the core of the amplifying optical fiber at the ends of this amplifying optical fiber. However, such a pumping method does not enable the energy of the pump luminous flux to be distributed homogeneously along the amplifying optical fiber, and requires very high optical power to be introduced into certain points of the amplifying optical fiber.

To improve the homogeneity of this distribution, it has been proposed to introduce the pump luminous flux into an amplifying optical fiber via at least one lateral pumping device, placed between the two ends of the amplifying optical fiber.

Such a lateral pumping device, which can be complementary to pumping devices located at the ends of the amplifying optical fiber, usually comprises a passive pumping optical fiber, which conducts a optical pump flux. This pumping optical fiber is joined, for example by welding, to the optical cladding of the amplifying optical fiber, at a segment of the amplifying optical fiber from which the outer covering has been removed. This assembly of the pumping optical fiber to the optical cladding is carried out in such a way that the optical pump flux circulating in the pumping optical fiber passes through the optical cladding of the amplifying optical fiber.

The introduction of a pump luminous flux by such a lateral pumping device is, for example, disclosed in documents EP2618191B1 or US2015/0007615A1.

The increase in temperature in a laser amplifier, due in particular to the emission of heat during optical amplification, is known to be a factor limiting the amplification power in an amplifying optical fiber. This increase in temperature can lead to a loss of quality in the amplified light beam, or even destruction of the laser amplifier.

In laser amplifiers comprising one or more lateral pumping devices, the junction zones between the amplifying optical fiber and the pumping optical fibers are particularly prone to temperature rises, increasing the risk of degrading the quality of the laser beam produced or destroying the laser amplifier.

At these junctions, the amplifying optical fiber receives a particularly high pump power, which leads to particularly strong excitation of the doping ions located in this zone. This excitation, and the subsequent de-excitation, generates a significant amount of heat.

In addition, the junction between a pumping fiber and the amplifying optical fiber carries a great deal of optical power. This optical power is likely to generate heat in any impurities or irregularities that may appear, particularly at the weld between fibers.

Finally, thermal energy dissipation is generally less efficient at this junction between the amplifying optical fiber and the pumping fiber. In fact, this junction is made on a segment of the amplifying optical fiber that is stripped of its outer covering, generally made of polymer materials, which helps dissipate the thermal energy of the amplifying optical fiber.

Such a junction zone between an amplifying optical fiber and a lateral pumping device is therefore particularly fragile and sensitive to heating. As a result, these lateral pumping devices are rarely used to amplify very high-power laser beams.

### SUMMARY OF THE INVENTION

The present invention aims to overcome these disadvantages of the prior art.

In particular, the aim of the invention is to enable very high-power light amplification in fiber laser amplifiers.

A particular aim of the invention is to increase the power of the light amplification obtainable by fiber laser amplifiers equipped with lateral pumping devices.

Another aim of the invention is to reduce the risk of heat-induced degradation of beam quality, or heat-induced destruction of fiber laser amplifiers equipped with lateral pumping devices.

These objectives, and others that will become clearer later on, are achieved using a fiber optical amplifier, this amplifier comprising an amplifying optical fiber, itself comprising at least one doped core, at least one optical cladding surrounding the core(s), and an outer covering surrounding the optical cladding(s), this optical amplifier comprising at least one lateral pumping device, itself comprising a pumping optical fiber joined to the optical cladding of the amplifying optical fiber, or to at least one of these optical claddings, at a junction zone located between the two ends of the amplifying optical fiber, so as to enable the transfer into the optical cladding, or into at least one of the optical claddings, of at least part of a pump luminous flux propagating in the pumping optical fiber. According to the invention, the outer covering is made of a material with a thermal conductivity coefficient greater than 1 W/m·K, and covers at least 90% of the perimeter of the amplifying optical fiber, at a first segment of said amplifying optical fiber, located between said junction zone and a first end of said amplifying optical fiber, and at a second segment of said amplifying optical fiber, located between said junction zone and a second end of said amplifying optical fiber. According to the invention, the outer covering also covers part of the perimeter of said amplifying optical fiber, at the segment of said amplifying optical fiber comprising the junction zone, and extending between the first segment and the second segment of the amplifying optical fiber, so that the outer covering extends uninterrupted between the first and second segments of the amplifying optical fiber.

In this way, the outer covering of the amplifying optical fiber can effectively distribute and dissipate the heat generated in the amplifying optical fiber, including in the junction zone, which is particularly prone to heat damage. This improvement in heat dissipation at the junction zone advantageously increases the amplification power of the amplifying optical fiber, without increasing the risk of damage to the amplifying optical fiber.

The core and the optical cladding(s) are designed to guide a luminous flux into the optical fiber. They are therefore made of a transparent material, often silica-based, capable of transmitting the luminous flux.

In contrast, the outer covering is usually made of a non-transparent material, most often opaque.

The material constituting this outer covering has a thermal conductivity coefficient which is preferably greater than 2 W/m·K, even more preferentially greater than 5 W/m·K, and which can be, particularly advantageously, greater than 30 W/m·K.

Preferably, the outer covering completely covers the perimeter of the amplifying optical fiber at the first and second segments of the amplifying optical fiber.

This situation corresponds to the majority of cases where the outer covering surrounds the entire perimeter of an optical fiber. However, the invention can also be applied to situations where the outer covering does not completely cover the perimeter of the optical fiber.

It should be noted that while the first and second segments are located between the junction zone and the ends of the optical fiber, they do not necessarily extend to these ends. Thus, for example, when the fiber optical amplifier comprises several lateral pumping devices, these first or second segments can be located between the junction zones of two lateral pumping devices.

According to a particularly advantageous embodiment, the outer covering is made of a metallic material.

“Metallic material” is understood to mean a metal or metal alloy. Such metallic outer coverings for optical fibers are well known in the prior art, and the methods for obtaining them are well mastered. Their use on the amplifying optical fiber of the invention is particularly advantageous, owing to their excellent thermal conductivity, which enables good heat dissipation.

Advantageously, the pumping optical fiber is joined to the optical cladding of the amplifying optical fiber by welding at the junction zone.

Preferably, the outer covering covers at least 50% of the perimeter of the amplifying optical fiber, at the segment of the amplifying optical fiber comprising the junction zone and extending between the first segment and the second segment of the amplifying optical fiber.

Thus, advantageously, the outer covering covers at least 50% of the perimeter of the amplifying optical fiber over the entire length of the amplifying optical fiber.

The entire length of the amplifying optical fiber is thus covered, over a significant part of its diameter, by an outer covering for heat dissipation.

Preferably, the cross-sectional area of the core, or the sum of the cross-sectional areas of the cores, is greater than 400 μm².

Such cores advantageously allow multi-mode beam propagation. By way of example, if there is only one core, it can advantageously have a diameter greater than 30 μm.

Advantageously, the fiber optical amplifier comprises at least two lateral pumping devices, each of these lateral pumping devices being connected to the amplifying optical fiber at one of said junction zones.

Multiplying the number of such lateral pumping devices greatly increases the amplification of the fiber optical amplifier. It is therefore advantageous to have at least ten lateral pumping devices on a fiber optical amplifier.

Advantageously, these junction zones are evenly distributed along the length of the amplifying optical fiber.

In an advantageous embodiment, the amplifying optical fiber has at least two distinct optical claddings, a first optical cladding surrounding the core(s) and an outer optical cladding surrounding the first optical cladding.

Preferably, the outer optical cladding is cut at the junction zone(s).

Cutting the outer optical cladding in this way enables the pumping optical fiber to be joined to the first optical cladding surrounding the core(s).

Cutting of the cladding at the junction zone can advantageously be carried out by laser ablation. This laser ablation can also cut the outer optical cladding, if required.

Thus, the present invention also relates to a method of manufacturing a fiber optical amplifier as described above, which comprises a step of local laser ablation of the outer covering to form the junction zone, over a portion of the perimeter of said amplifying optical fiber covering no more than 50% of the perimeter of the amplifying optical fiber.

### BRIEF DESCRIPTION OF THE DRAWINGS

The invention will be better understood upon reading the following description of preferential embodiments, given by way of a simple figurative, non-limiting example, and accompanied by the figures.

FIG. 1 is a schematic cross-sectional view, in an axial plane, of a segment of a fiber laser amplifier according to one embodiment of the invention.

FIG. 2 is a perspective view of the portion of the fiber optical amplifier shown in FIG. 1.

### DETAILED DESCRIPTION OF THE PREFERRED EMBODIMENTS

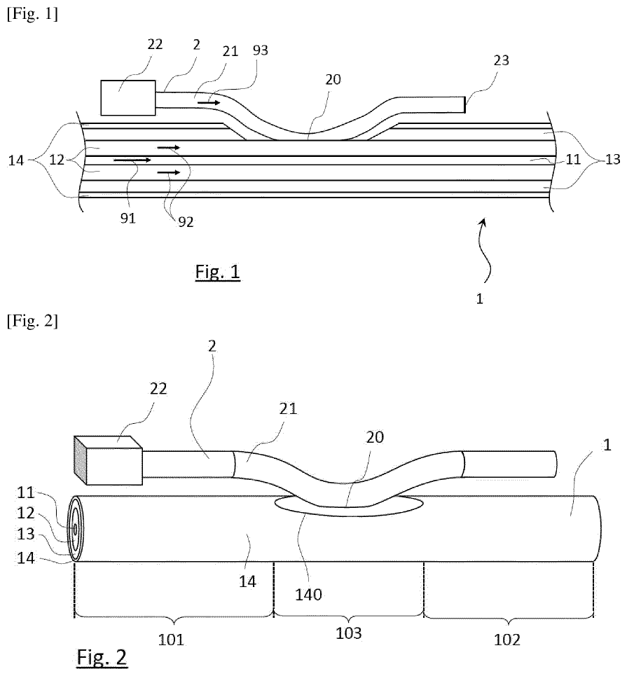

FIG. 1 thus schematically shows a cross-sectional view in an axial plane of a segment of a fiber laser amplifier wherein light radiation is amplified as it propagates along an amplifying optical fiber 1. This fiber laser amplifier can be included in a laser cavity, or used to amplify a previously formed laser beam.

As is well known to those skilled in the art, the amplifying optical fiber 1 comprises a core 11 surrounded by an optical cladding 12. As is well known, the core 11 consists of a silica matrix doped with rare-earth ions (for example, Ytterbium ions) to form an optical amplifier medium. This core of the optical fiber is designed to guide the light beam 91 to be amplified. In the shown embodiment, this core has a diameter of around 50 μm.

In other embodiments, the amplifying optical fiber can, as is well known, have several cores. The present invention is equally applicable to such multicore amplifying optical fibers.

The core 11 is surrounded by an optical cladding 12, which is, as is well known, made of silica with a refractive index lower than that of the core 11 it surrounds. This index jump advantageously keeps the light beam 91 to be amplified in the core 11, without it being able to escape into the optical cladding 12.

The optical cladding 12 is itself capable of guiding a light beam along the amplifying optical fiber 1. A so-called “pump” luminous flux 92 is introduced into this optical cladding 12. As it propagates along the optical cladding 12, this pump luminous flux 92 passes through the doped core 11, where its photons are absorbed by the doping ions of the core 11, which then enter an excited state. These excited doping ions of the core 11 then amplify the light beam 91 to be amplified propagating in the core 11.

The optical cladding 12 surrounding the core 11 of the amplifying optical fiber 1 must guide the pump luminous flux 92. To achieve this, in the embodiment shown, this optical cladding 12 is surrounded by another optical cladding, the so-called outer optical cladding 13, whose refractive index is lower than that of the optical cladding 12 surrounding the core 11, so that the index jump prevents the pump luminous flux 92 from escaping from the optical cladding 12 surrounding the core 11.

In the embodiment shown, the outer optical cladding 13 surrounding the optical cladding 12 surrounding the core 11 is surrounded by an outer covering 14, which prevents any leakage of light flux outside the amplifying optical fiber 1 and helps protect the amplifying optical fiber 1 from mechanical stress.

According to the invention, this outer covering 14 is made of a material with high thermal conductivity. As a result, this material has a thermal conductivity coefficient greater than 1 W/m·K, which is higher than that of the polymeric materials commonly used for the outer covering of optical fibers. Preferably, this thermal conductivity coefficient is greater than 2 W/m·K. Even more preferentially, this thermal conductivity coefficient is greater than 5 W/m·K. It is particularly advantageous if this thermal conductivity coefficient is greater than 30 W/m·K, which is the case for most metallic materials.

For example, the outer covering 14 can be made of a metallic material, or another material with high thermal conductivity, such as a composite or organic material.

In the majority of cases, the material constituting the outer covering 14 is a non-transparent material, most often opaque. Such a solution is often advantageous, as non-transparent or opaque materials with high thermal conductivity are easy to obtain. Furthermore, the outer covering does not normally need to transmit luminous flux. On the contrary, its function is often to reflect the entire luminous flux flowing through the fiber.

It is particularly advantageous to produce this covering in a metallic material. Such outer metallic coverings for optical fibers are, in themselves, known to those skilled in the art. In particular, they are known to offer higher mechanical strength and heat resistance than conventional polymer coverings. In addition to these characteristics, outer metallic coverings have a much higher thermal conductivity than polymer coverings. They can therefore make a greater contribution to the distribution and dissipation of heat from the amplifying optical fiber 1.

Such an outer covering 14 can, for example, be made of a metal such as gold, aluminum or copper, which have a very high thermal conductivity (generally in excess of 200 W/m/K). Methods for manufacturing optical fibers coated with such outer metallic coverings are known to the person skilled in the art.

To achieve very high-power amplification, a very high-power pump luminous flux 92 must be introduced into the optical cladding 12 of the amplifying optical fiber 1.

Part of this pump luminous flux 92 can be introduced into the optical cladding 12 surrounding the core 11 of the amplifying optical fiber 1 at the ends of this amplifying optical fiber 1, according to a conventional technique well known to those skilled in the art.

In the embodiment shown, at least part of this pump luminous flux propagating in the amplifying optical fiber 1 is introduced by one or more lateral pumping devices 2.

The fiber laser amplifier segment shown in FIG. 1 shows such a lateral pumping device 2, fitted to the amplifying optical fiber 1. The fiber amplifier may, however, include a plurality of such lateral pumping devices 2, for example distributed along its length, and may also include pumping devices at the ends of the amplifying optical fiber 1.

The lateral pumping device 2 shown in FIG. 1 comprises a pumping optical fiber 21, which conducts a luminous flux 93 produced by a light-emitting diode 22. This pumping optical fiber 21 is joined, for example by welding, to the optical cladding 12 of the amplifying optical fiber 1, at a junction zone 20 where the outer covering 14 of the amplifying optical fiber 1 has been removed. This assembly of the pumping optical fiber 21 to the optical cladding 12 is carried out in such a way that at least part of the luminous flux 93 propagating in the pumping optical fiber 21 passes, at the junction zone 20, into the optical cladding 12, to form the pump luminous flux 92.

In the embodiment shown, the portion of luminous flux 93 that does not pass directly through the optical cladding 12 and remains in the pumping optical fiber 21 is reflected by a mirror 23 placed at the end of the pumping optical fiber 21. It can then pass into the optical cladding 12 during a second pass through the junction zone 20.

Assembling the lateral pumping device on the amplifying optical fiber 1 is known to involve removing the outer covering 14 from a portion of the amplifying optical fiber 1.

In prior art solutions, when the outer covering is made of polymers, it is possible to cut this outer covering on a section of the optical fiber, to remove it and thus strip an entire section of the amplifying optical fiber.

However, according to the invention, a different method is used to remove the outer covering 14 from a portion of the amplifying optical fiber 1. Thus, advantageously, the removal of the outer covering 14 is carried out only on the portion of the perimeter of the amplifying optical fiber 1 to which the pumping optical fiber 21 is to be welded, and not on the whole of this perimeter.

FIG. 2, which shows a perspective depiction of the portion of the fiber optical amplifier shown in FIG. 1, shows such a cutout 140 in the outer covering 14. Three successive segments can be distinguished on the portion of amplifying optical fiber 1 shown. At a first segment 101 of the amplifying optical fiber 1, located on one side of the junction zone 20 (that is, between this junction zone 20 and a first end of the amplifying optical fiber 1), the outer covering 14 completely covers the amplifying optical fiber 1. Likewise, at a second segment 102 of the amplifying optical fiber 1, located on the other side of the junction zone 20 (that is, between this junction zone 20 and a second end of the amplifying optical fiber 1), the outer covering 14 completely covers the amplifying optical fiber 1. By contrast, the segment 103 of the amplifying optical fiber 1, which extends between the first segment 101 and the second segment 102, corresponds to the part of the amplifying optical fiber 1 on which the cutout 140 is formed in the outer covering. This segment 103 therefore comprises the junction zone 20, which is formed in the cutout 140 of the outer covering 14. At this segment 103, the outer covering 14 covers only part of the perimeter of the amplifying optical fiber 1. However, this outer covering is not completely removed at the junction zone 20, so that it extends uninterrupted between the first segment 101 and the second segment 102 of the amplifying optical fiber.

Thus, advantageously, the outer covering 14 surrounding the amplifying optical fiber 1 continues continuously over the amplifying optical fiber 1. In fact, this outer covering 14 completely surrounds this amplifying optical fiber 1 on both sides of the junction zone 20 of the lateral pumping device 2 on this amplifying optical fiber 1, and covers part of the perimeter of this amplifying optical fiber 1, at this junction zone 20. Preferably, at this junction zone 20, the outer covering 14 covers between 50% and 80% of the perimeter of the amplifying optical fiber 1

Removal of the outer covering 14, on the portion of the perimeter of the amplifying optical fiber 1 whereupon the pumping optical fiber 21 is to be welded, can advantageously be carried out by laser ablation of this outer covering 14, which is advantageously limited to the zone whereupon the junction is to be made. To achieve this, a laser is focused on the surface to be ablated, and the photons heat up and tear away the material. Moving the focal point determines the surface to be ablated.

Such laser ablation of the outer covering 14 has the advantage of being able to be carried out efficiently, independently of the material making up the outer covering. In this way, it can effectively remove coverings, such as certain metallic coverings, which adhere strongly to the optical fiber they surround, and which cannot be easily removed by a mechanical stripping operation.

When the outer covering 14 is removed, the outer optical cladding 13 may also be cut, when the amplifying optical fiber 1 comprises such an outer optical cladding 13, to enable the pumping optical fiber 21 to be welded directly onto the optical cladding 12 surrounding the core 11.

The continuous presence of the outer covering 14, over at least part of the perimeter of the amplifying optical fiber 1, enables thermal energy to be distributed and dissipated much more efficiently than in previous solutions for amplifying fiber lateral pumps.

This solution therefore makes it possible to significantly increase the pumping power injected into the amplifying optical fiber 1, and thus the amplification power of this amplifying optical fiber 1. The outer covering, which is preferentially continuous along the entire length of the fiber, enables heat to be distributed and dissipated, thereby greatly reducing the risk of degradation of the light beam due to a local rise in temperature, and the risk of destruction of the fiber optical amplifier by an excessive rise in temperature. This good temperature dissipation makes it possible to introduce very high pumping power, via lateral pumping devices 2, which enable pump energy to be distributed evenly over the length of the pump.

The use of the solution according to the invention therefore makes it possible to push back the limits that hinder the production of very high-power laser beams by amplifying optical fibers.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-11. (canceled)

12. A fiber optical amplifier, said fiber optical amplifier comprising:
an amplifying optical fiber comprising
at least one doped core,
at least one optical cladding surrounding said at least one doped core, and
an outer covering surrounding said at least one optical cladding: and, at least one lateral pumping device comprising
a pumping optical fiber joined to said at least one optical cladding of said amplifying optical fiber at a junction zone located between two ends of said amplifying optical fiber, so as to enable a transfer into said at least one optical cladding of at least part of a luminous flux propagating in said pumping optical fiber,
wherein said outer covering is made of a material with a thermal conductivity coefficient greater than 1 W/m·K,
wherein said outer covering covers at least 90% of a perimeter of the amplifying optical fiber, at a first segment of said amplifying optical fiber, located between said junction zone and a first end of said amplifying optical fiber, and at a second segment of said amplifying optical fiber, located between said junction zone and a second end of said amplifying optical fiber,
wherein said outer covering covers a part of the perimeter of said amplifying optical fiber, at a segment of said amplifying optical fiber comprising said junction zone, and extending between said first segment and said second segment of said amplifying optical fiber, so that said outer covering extends uninterrupted between said first segment and second segment of said amplifying optical fiber.

13. The fiber optical amplifier according to claim 12, wherein said outer covering completely covers the perimeter of said amplifying optical fiber at said first segment and second segment of said amplifying optical fiber.

14. The fiber optical amplifier according to claim 12, wherein said outer covering is made of a metallic material.

15. The fiber optical amplifier according to claim 12, wherein an assembly of said pumping optical fiber to said at least one optical cladding of said amplifying optical fiber is done by welding at said junction zone.

16. The fiber optical amplifier according to claim 12, wherein said outer covering covers at least 50% of the perimeter of said amplifying optical fiber, over an entire length of said amplifying optical fiber.

17. The fiber optical amplifier according to claim 16, wherein a cross-sectional area of said at least one doped core, or a sum of cross-sectional areas of all doped cores, is greater than 400 μm².

18. The fiber optical amplifier according to claim 12, further comprising:
two lateral pumping devices, each of said lateral pumping devices being connected to said amplifying optical fiber at a junction zone.

19. The fiber optical amplifier according to claim 18, wherein said junction zones are evenly distributed along a length of said amplifying optical fiber.

20. The fiber optical amplifier according to claim 12, wherein said amplifying optical fiber comprises at least two optical claddings, a first optical cladding surrounding said at least one doped core, and an outer optical cladding surrounding said first optical cladding.

21. The fiber optical amplifier according to claim 20, wherein said outer optical cladding is cut at said junction zone.

22. A method of manufacturing the fiber optical amplifier according to claim 12, the method comprising the steps of:
local laser ablation of said outer covering to form said junction zone, over a portion of the perimeter of said amplifying optical fiber covering no more than 50% of the perimeter of said amplifying optical fiber.
